(19) United States
(12) Patent Application Publication
(10) Pub. No.: US 2015/0162663 A1
(43) Pub. Date: Jun. 11, 2015

(54) METAL-ONLY DIELECTRIC-FREE BROADBAND APERTURE-COUPLED PATCH ARRAY

(71) Applicant: Nuvotronics, LLC, Radford, VA (US)

(72) Inventors: Anatoliy O. Boryssenko, Belchertown, MA (US); Kenneth Vanhille, Cary, NC (US)

(21) Appl. No.: 14/567,373

(22) Filed: Dec. 11, 2014

Related U.S. Application Data
(60) Provisional application No. 61/914,913, filed on Dec. 11, 2013.

(51) Int. Cl. H01Q 9/04; H01Q 21/06; H01Q 1/48

(52) U.S. Cl. CPC H01Q 9/0478; H01Q 1/48; H01Q 21/065

(57) ABSTRACT

Patch arrays, including metal-only, dielectric-free, broadband aperture-coupled patch arrays.

### RELATED APPLICATIONS

This is application claims the benefit of priority of U.S. Provisional Application No. 61/914,913, filed on Dec. 11, 2013, the entire contents of which application are incorporated herein by reference.

### FIELD OF THE INVENTION

The present invention relates generally to patch arrays, and more particularly, but not exclusively, to metal-only, dielectric-free, broadband aperture-coupled patch arrays.

### BACKGROUND OF THE INVENTION

Patch arrays are very attractive for many applications because of their conformal features and they can be fabricated in a relatively low-cost fashion with printed circuit boards (PCBs). Patch arrays can support arbitrary polarization states and are suitable for integration with front-end PCB electronics. However, such arrays are of very narrow bandwidth reaching at the best 10-12% in quite complex multi-layer stacked designs. Also, substrate losses and restrictions of PCB fabrication processes (tolerances, width of signal traces and others) limit their utility.

### SUMMARY OF THE INVENTION

In one of its aspects the present invention relates to the design of broadband, dielectric-free patch array elements intended to radiate with high polarization purity across wide operational bandwidths of 20-25% or more with scanning capabilities to 45 degrees or more from broadside. In one exemplary configuration the proposed patch element design may include a solid metal patch radiator mounted on a ground plane with a central metal post that is placed in the area of virtually zero electromagnetic fields and, thus, if not too thick, the post will not impact bandwidth and will not induce monopole-type of radiation. The ground plane may include a slot for single linear polarizations or two slots for two orthogonal linear polarizations. The slots may be cut in the ground plane, and may be shaped like a dog-bone to support wider bandwidths compared to just rectangular shaped slots. In addition, the solid strip line conductor of a feed network may be placed below the ground plane at a selected distance below the ground plane. A metal plate may be provided below the strip line to provide a cavity enclosing the feed network. One end of the solid stripline may be routed to the bottom of the ground plane and pass through the ground plane, making the feed network accessible from below, for example, by using a micro-coaxial feed port or other method of feeding. The other end of the strip line may be terminated with an open circuit section of certain length, which may be nominally a quarter of a wavelength at the center of the band of operation. The feed network may also be isolated by vertical walls at the boundary between unit cells and, for example, a diagonal vertical metal wall can isolate two networks of the same array cell that operate at two different polarizations.

Arrays of the present invention can be designed to meet certain required electrical features through a design optimization process to come up with proper dimensional selections, such as the patch-square side size, height and outer edge shapes. In particular, different patch shapes may favor some performance aspects (while other performance aspects may suffer), such as achievable bandwidth, scan volume and polarization purity. In general, higher patch elevation above the ground plane may contribute to wider bandwidth but at the cost of higher cross-polarization radiation. Meandering, cutting or otherwise shaping the patch outline may help to reach certain multi-objective optimality that involves bandwidth, scan volume and polarization purity. Other sets of structural shapes that may be desirable include: (i) size and shape of coupling slot; (2) cross-section and 3-D routing of solid strip line and its position within the bottom feed network cavity; and, (iii) feed network cavity volume along with its 3-D shape accounting for isolation of two orthogonal polarizations.

The array elements may be made of only metal parts including two major functional elements such as a patch radiator and a feed-network integrated into a single modular design. The array can support arbitrary polarization states. Efficiency values of 80% or greater are expected, since only metal parts are employed without a dielectric substrate. Dielectric material can often be the dominant loss contributor and also contributes to smaller operational bandwidths. Thus, arrays of the present invention can considerably improve electrical features and allow fabrication of such arrays for higher frequencies up to submillimeter-wave bands using additive fabrication process such as PolyStrata® technology (for example, U.S. Pat. No. 7,012,489, U.S. Pat. No. 7,649,432, U.S. Pat. No. 7,948,335, U.S. Pat. No. 7,148,772, U.S. Pat. No. 7,405,638, U.S. Pat. No. 7,656,256, U.S. Pat. No. 7,755,174, U.S. Pat. No. 7,898,356, U.S. Pat. No. 8,031,037, US 2008/0199656 and US2011/0123783, 2010/0296252, 2011/0273241, 2011/0181376, 2011/0210807, the contents of which are incorporated herein by reference), 3-D printing (see WO 2013/010108, the contents of which are incorporated herein by reference), and others suitable processes with only metal (copper) components involved without need to employ any dielectric.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates an isometric view of a dielectric-free patch antenna in accordance with the present invention;

FIG. 2 schematically illustrates an isometric view of a further dielectric-free patch antenna in accordance with the present invention, with cutouts in the corners of the patch;

FIG. 3 schematically illustrates an isometric view of a dielectric-free patch antenna with cutouts in the corners of the patch and slots cut into the remaining edges of the patch;

FIG. 4a schematically illustrates an isometric view of yet a further dielectric-free patch antenna in accordance with the present invention, and FIG. 4b schematically illustrates an isometric view of the underside of the antenna in FIG. 4b with the lower ground plane removed;

FIG. 5 schematically illustrates a still further dielectric-free patch antenna in accordance with the present invention;

FIG. 6 schematically illustrates a side view of the dielectric-free patch antenna of FIG. 1;

FIG. 7 illustrates the performance of the antenna shown in FIG. 4 when the antenna unit cell is simulated in an array environment with a broadside excitation;

FIG. 8 illustrates the performance of the antenna shown in FIG. 4 when the antenna unit cell is simulated in an array environment with an excitation at Phi=0° and Theta=40°;

FIG. 9 illustrates that wideband performance is possible using this antenna topology, as is manifest by S11 for broadside radiation of the antenna shown in FIG. 5;

FIGS. 10A and 10B schematically illustrate two-dimensional and three-dimensional arrays, respectively, of patch antennas in accordance with the present invention.

### DETAILED DESCRIPTION OF THE INVENTION

In one of its aspects, devices of the present invention avoid the use of substrate materials that shrink operational bandwidth and unavoidably contribute to losses, weight and often cost. In this regard, a metal-only patch may be used with a central metal support made of single or several metal posts. The patches of the present invention may be driven through dog-bone-like coupling slots cut in the array ground plane. An integrated solid stripline-based feed network may be placed under the ground plane, and a bottom metal plane may form a cavity enclosing the feed network. The feed network may be isolated by vertical walls at the boundary between unit cells and, for example, a diagonal vertical metal wall may isolate two networks of the same array cell that operate at two different polarizations. All elements and in particular the patch and feed network (slot and stripline) may be much thicker than typical PCB conductors and, thus, show wider operational bandwidth and lower losses. These factors can contribute substantially to overall operational bandwidth and radiation efficiency. The devices may be fabricated from the bottom (the cavity floor) towards its top (the patch) in a layer-by-layer additive manufacturing process. The radiating patch and the feed network may both be fabricated during the same additive process.

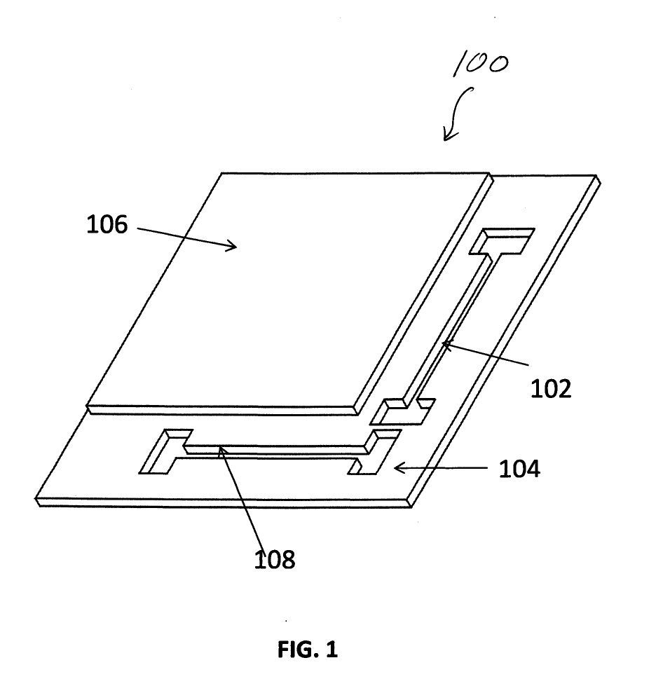

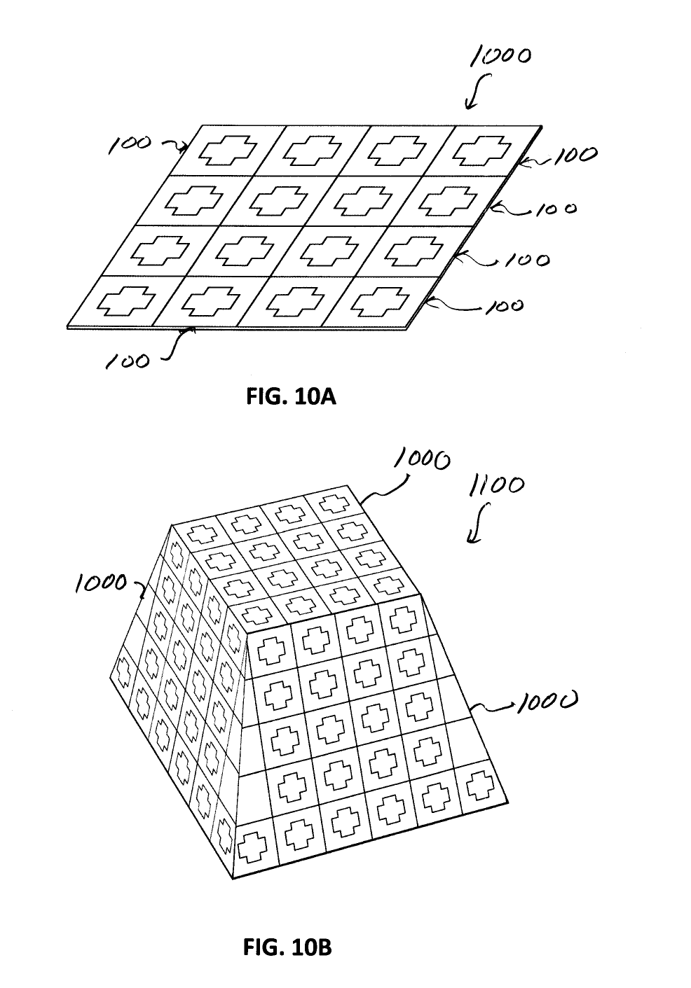

Referring now to the figures, wherein like elements are numbered alike throughout, FIG. 1 schematically illustrates an isometric view of a dielectric-free patch antenna 100 in accordance with the present invention including a radiating metal patch 106 and a metal ground plane 104 for the patch 106. The ground plane 104 may include dog-bone-shaped slots 102, 108 that feed electromagnetic energy between the patch 106 and the electronics of other circuit components (not shown). The dog-bone-shaped slots 102, 108 may excite the radiating metal patch 106 with orthogonal electromagnetic polarizations. The dog-bone-shaped slots 102, 108 may have other shapes, such as curved ends for the dog-bones or could be completely rectangular in shape without the dog-bone end-structure. However, the dog-bone-shaped slots 102, 108 may provide greater bandwidth of operation than a simple rectangular shape. The geometry shown could be tiled to create a 2-dimensional array 1000 of patch antenna elements 100, FIG. 10A, or a three-dimensional array 1100 of patch antenna elements 100, FIG. 10B, with the 2-dimensional arrays 1000 tiled along a curved or faceted surface, for example. This may be done to increase the directivity or gain of the antenna by creating an array. The dog-bone-shaped slots 102, 108 may excite a broadside excitation for the radiating metal patch 106, in which the electric field vector is perpendicular to the long dimension of slots 102, 108 and parallel to the plane of the radiating metal patch 106.

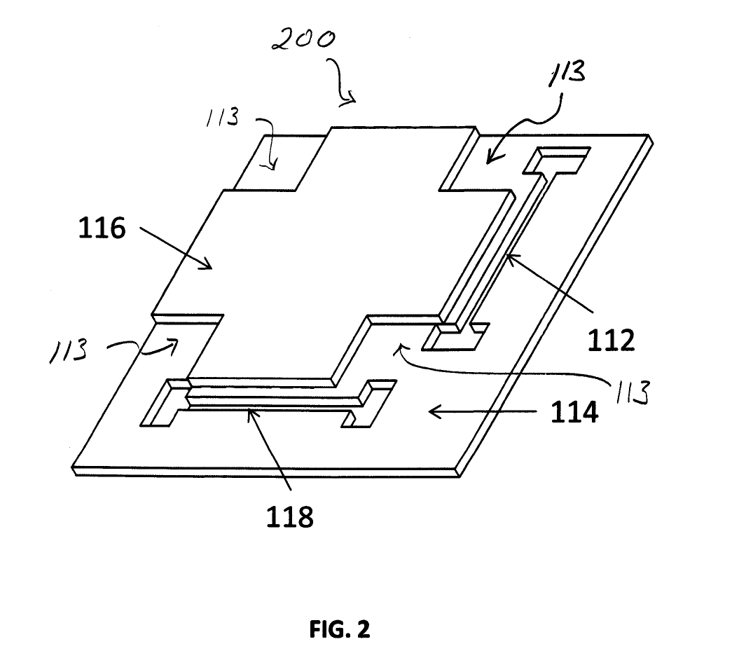

FIG. 2 schematically illustrates an isometric view of a further dielectric-free patch antenna 200 in accordance with the present invention, with cutouts 113 in the corners of a radiating metal patch 116. A metal ground plane 114 may be provided for the patch 116 and may include dog-bone-shaped slots 112, 118 that feed electromagnetic energy between the patch 106 and the electronics of other circuit components (not shown). The cutouts 113 may increase the cross polarization isolation between the polarizations excited by the dog-bone-shaped slots 112, 118. As per the structure of FIG. 1, the slots 112, 118 could have other shapes such as curved ends for the dog-bones or could be completely rectangular in shape without the dog-bone end-structure. The geometry shown in FIG. 2 could be tiled to create a two-dimensional array of patch antenna elements 200 or a three-dimensional array of patch antenna elements 200, tiled along a curved or faceted surface, such as the two-dimensional and/or a three-dimensional arrays of FIGS. 10A, 10B, for example. This may be done to increase the directivity or gain of the antenna by creating an array.

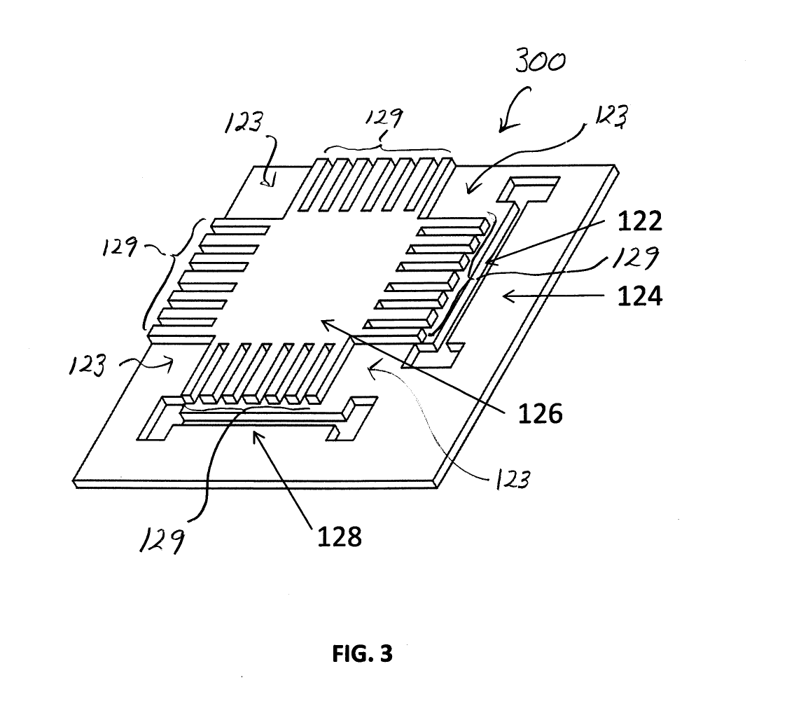

FIG. 3 schematically illustrates an isometric view of a dielectric-free patch antenna 300 in accordance with the present invention, with cutouts 123 in the corners of the patch 142 and patch slots 129 cut into the remaining edges of the patch 142. The patch slots 129 could extend further than the corner cutouts 123 or the patch slots 129 could be shorter. A metal ground plane 124 may be provided for the patch 126 and may include dog-bone-shaped slots 122, 128 that feed electromagnetic energy between the patch 106 and the electronics of other circuit components (not shown). The combination of the patch slots 129 and cutouts 123 can increase the cross polarization isolation between the polarizations excited by dog-bone-shaped slots 122, 128, although other methods than those illustrated here could also be used. The geometry shown could be tiled to create a two-dimensional array of patch antenna elements 300 or a three-dimensional array of patch antenna elements 300, tiled along a curved or faceted surface, such as the two-dimensional and/or a three-dimensional arrays of FIGS. 10A, 10B, for example. This may be done to increase the directivity or gain of the antenna by creating an array.

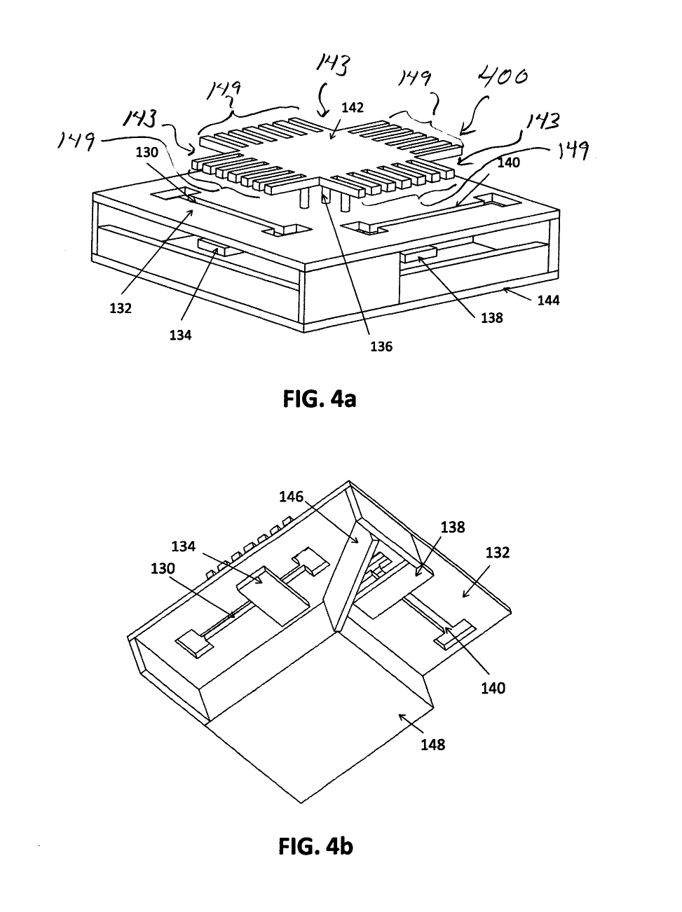

FIG. 4a schematically illustrates an isometric view of yet a further dielectric-free patch antenna 400 in accordance with the present invention, and FIG. 4b schematically illustrates an isometric view of the underside of the antenna 400 in FIG. 4b with the lower ground plane removed. The antenna 400 includes a radiating metal patch 142 and a metal ground plane 132 for the patch 142. The patch 142 is shown with corner cutouts 143 and polarization-isolation-enhancing patch slots 149 cut into the patch 142, although the patches 106, 126 of FIGS. 1, 2 could also be used. The ground plane 132 may include dog-bone-shaped slots 130, 140 that feed electromagnetic energy between the patch 142 and feed structures 134, 138. The dog-bone-shaped slots 130, 140 may excite the radiating metal patch 142 with orthogonal electromagnetic polarizations. The dog-bone-shaped slots 130, 140 may have other shapes, such as curved ends for the dog-bones or could be completely rectangular in shape without the dog-bone end-structure. However, the dog-bone-shaped slots 130, 140 may provide greater bandwidth of operation than a simple rectangular shape.

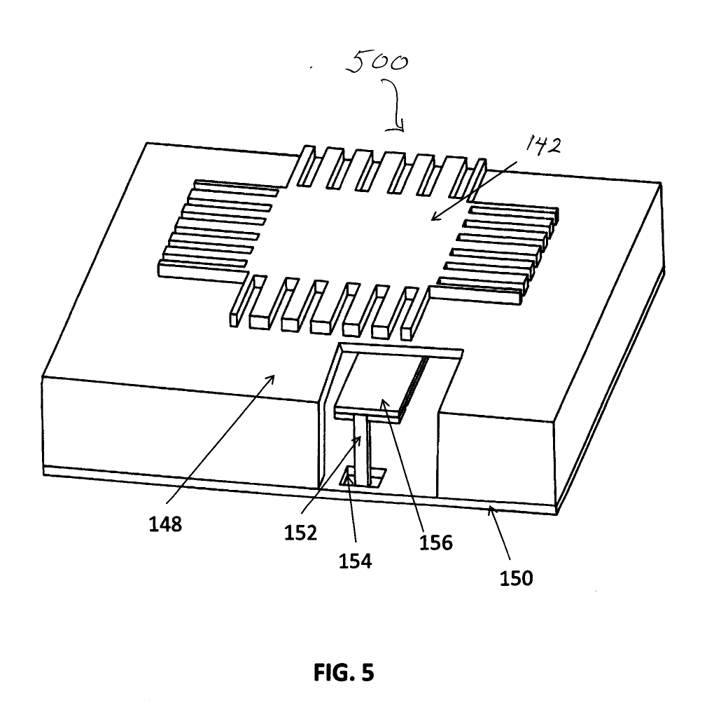

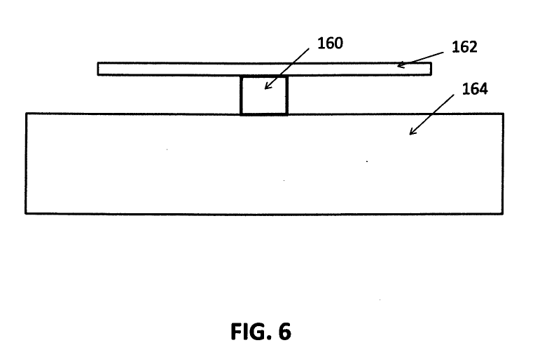

The dog-bone coupling slots 130, 140 may be fed by stripline feed structures 134, 138 with open-circuited stubs, FIG. 4a, 4b, 5. One or more posts 136 may be provided that support the patch 142 above the ground plane 132. For instance, a single post 160 configuration is shown in FIG. 6 between the ground plane 164 and patch 162. The posts 160, 136 could be metal, a dielectric, or a combination of the two, and could be cylindrical or rectangular and may be sized to have minimal electromagnetic impact on the performance of the antenna, while providing the necessary support. The fact that these posts 160, 136 could be a dielectric does not substantively change the concepts taught in this invention. The fact that the group of posts 136 is not shown in FIGS. 1-3, 5 does not imply that such a structure may not be part of those antennas. A wall 146 may be provided to separate the coupling regions proximate feed structures 134, 138, which increases the cross-polarization isolation, FIG. 4b. A block 148 may be provided to perform a similar function, and walls could extend around the entire unit cell of the patch antenna 500 to prevent coupling from one antenna element to the next, FIG. 5.

FIG. 5 schematically illustrates a further dielectric-free patch antenna 500 in accordance with the present invention. A metallic patch antenna 146 is provided with the corners cutout and with slots cutout for improved cross polarization isolation. The antenna ground plane 148 is shown cut away, for illustration purposes only, to show the excitation of the stripline feed 156. A direct-coupled vertical feed 152 may be provided that passes through an aperture 154 in the lower ground plane 150. This feed structure 152 could go directly to commercial blind-mate connectors, such as the Corning Gilbert GPPO®. This feed structure 152 could transition to a stripline or microstrip or other transmission line technology on a multi-layer circuit board with the rest of the electronics, or could transition to rectangular coaxial transmission lines such as those fabricated using PolyStrata® technology.

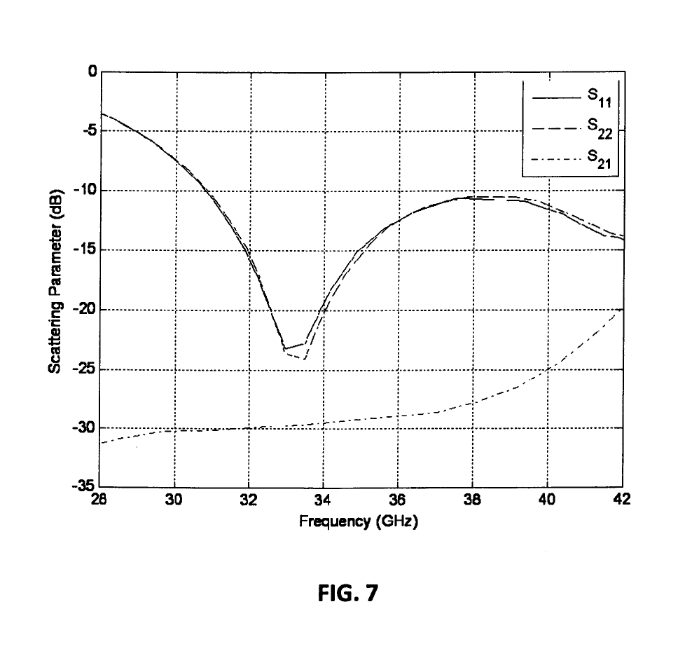

FIG. 7 illustrates the performance of the antenna 400 shown in FIG. 4 when the antenna unit cell is simulated in an array environment with a broadside excitation using periodic boundary conditions in a commercial, full-wave electromagnetic simulation software package, such as ANSYS HFSS™. The cross polarization isolation is high, as manifest by S21 and S11 is plotted for both port 1 and port 2, excitation of slots 130, 140, respectively. This demonstrates that the antenna 400 is capable of broadband performance.

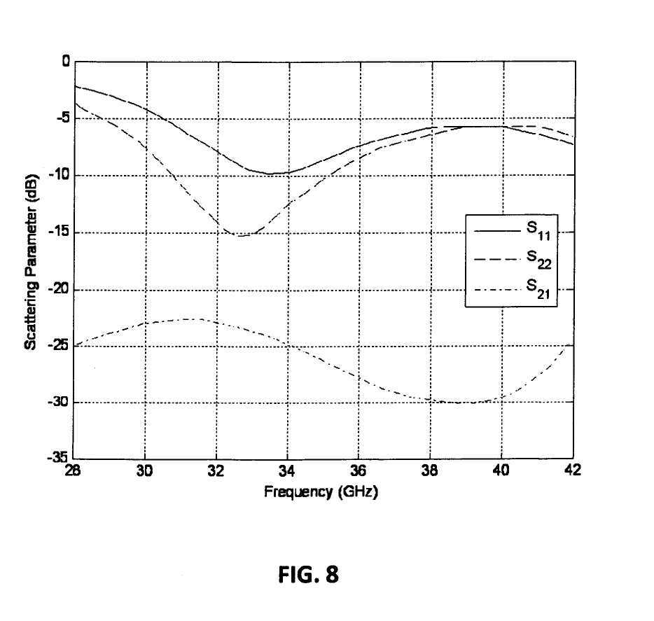

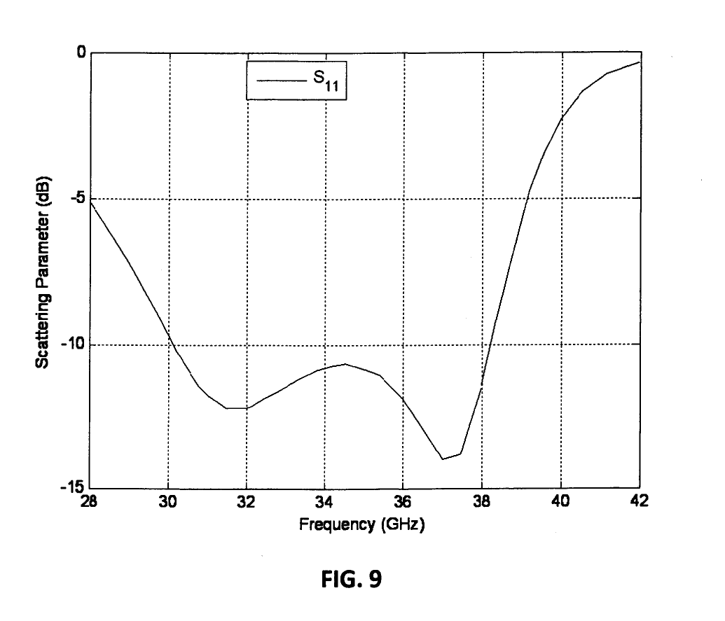

FIG. 8 illustrates the performance of the antenna 400 shown in FIG. 4 when the antenna unit cell is simulated in an array environment with an excitation at Phi=0° and Theta=40°, using periodic boundary conditions in a commercial, full-wave electromagnetic simulation software package, such as ANSYS HFSS™ Phi=0° is oriented perpendicular to the long dimension of slot 130 and Theta=40° is down 40° from broadside. The cross polarization isolation is high, as manifest by a low S21 and S11 is plotted for both port 1 and port 2. This demonstrates that the antenna 400 is capable of broadband performance in a scanned condition. FIG. 9 illustrates that wideband performance is possible using this antenna topology, as is manifest by S11 for broadside radiation of the antenna 500 shown in FIG. 5.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A patch antenna, comprising:
a radiating patch having a generally rectangular shape with notched corners to provide plus-shaped geometry;
a ground plane proximate the patch, the ground plane including a plurality of dog-bone-shaped apertures disposed therein; and
a metal post connected to the patch and the ground plane to support the patch above the ground plane.

2. The patch antenna according to claim 1, wherein patch and ground plane are disposed in spaced apart relation to one another with a substantially dielectric free region therebetween.

3. The patch antenna according to claim 1, wherein the patch comprises a plurality of slots disposed therein.

4. The patch antenna according to claim 1, wherein the patch comprises metal.

5. The patch antenna according to claim 1, wherein the apertures comprise a curved dog-bone shape.

6. (canceled)

7. A two-dimensional patch array of comprising a plurality of antennas of any one of the preceding claims.

8. A plurality two-dimensional arrays according to claim 7, arranged to provide a three-dimensional array.
